(19) United States
(12) Patent Application Publication
(10) Pub. No.: US 2026/0025733 A1
(43) Pub. Date: Jan. 22, 2026

(54) COVERAGE CHANGE INDICATION FOR RELAY PATH SWITCHING

(71) Applicant: Kyocera Corporation, Kyoto (JP)

(72) Inventors: Henry CHANG, San Diego, CA (US); Masato FUJISHIRO, Yokohama (JP)

(21) Appl. No.: 18/994,983

(22) PCT Filed: Aug. 1, 2023
(86) PCT No.: PCT/US2023/029211

§ 371 Date: Jan. 15, 2025

Related U.S. Application Data
(60) Provisional application No. 63/396,322, filed on Aug. 9, 2022.

(51) Int. Cl. H04W 40/22; H04B 17/318; H04W 88/04

(52) U.S. Cl. CPC H04W 40/22; H04B 17/328; H04W 88/04

(57) ABSTRACT

A relay user equipment (UE) device that is providing a relay communication link between a first UE device and a second UE device transmits a trigger message to the first UE device when cellular coverage status of the second UE device changes. The trigger message invokes the first UE device to execute a path switch to an alternate communication path between the first UE device and second UE device. The transmission of the trigger message is in response to receipt of a coverage change indicator at the relay UE device. In some situations. the trigger message is the message including the coverage change indicator received at the relay UE device and forwarded by the relay UE device.

### CLAIM OF PRIORITY

The present application claims priority to Provisional Application No. 63/396,322, entitled “U2U relaying Control Plane,” docket number TPRO 00376 US, filed Aug. 9, 2022, which is assigned to the assignee hereof and hereby expressly incorporated by reference in its entirety.

### FIELD

This invention generally relates to wireless communications and more particularly to coverage change indication for relay path switching.

### BACKGROUND

Sidelink relaying functionality allows a remote user equipment (UE) device that is out-of-coverage (OoC) to connect with the gNB or base station via a relay UE device. Relay functionality allows one UE device to connect to another UE device over a relay communication link going through at least one relay UE. In some situations, the relay communication link may also go through one or more base stations or gNBs.

### SUMMARY

A relay user equipment (UE) device that is providing a relay communication link between a first UE device and a second UE device transmits a trigger message to the first UE device when cellular coverage status of the second UE device changes. The trigger message invokes the first UE device to execute a path switch to an alternate communication path between the first UE device and second UE device. The transmission of the trigger message is in response to receipt of a coverage change indicator at the relay UE device. In some situations, the trigger message is the message including the coverage change indicator received at the relay UE device and forwarded by the relay UE device.

### BRIEF DESCRIPTION OF THE DRAWINGS

FIG. 1A is a block diagram of an example of a system where a relay UE device sends a trigger message to a first UE device (peer UE device) in response to receiving a coverage change indication message.

FIG. 1B is a block diagram of an example of the system where the relay UE device is facilitating a U2N relay link and the remote UE device (second UE device) transitions to out of coverage (OoC) of the cellular coverage regions.

FIG. 1C is a block diagram of an example of the system where the relay UE device is facilitating a U2U relay link and the remote UE device (second UE device) transitions from out of coverage (OoC) to in-coverage (InC) of the cellular coverage region of a gNB.

FIG. 2 is a block diagram of an example of a base station (gNB) suitable for use as the gNB.

FIG. 3 is a block diagram of an example of a UE device suitable for use as each of the UE devices.

FIG. 4 is a flow chart of an example of a method of sending cellular coverage change information to a first UE device regarding the change in coverage of a second UE device.

FIG. 5 is a flow chart of an example of a method of establishing an alternate communication path to second UE device in response to receiving message indicating that the cellular coverage to the second UE device has changed.

### DETAILED DESCRIPTION

Many wireless communication systems that employ several base stations that provide wireless service to user equipment (UE) devices enable sidelink communication between two or more UE devices where the UE devices can communicate directly with other UE devices. With sidelink communication, UE devices transmit data signals to each other over a communication link using the cellular resources instead of through a base station. Such Proximity Services (ProSe) communication is sometimes also referred to as device-to-device (D2D).

In addition, one or more UE devices can be used as relay devices between a UE device and a destination where the relay device forwards data between a UE device and the destination. The destination may be a communication network or another UE device (destination UE device). Where the destination is the network, the relay functionality is typically referred to as UE-to-Network (U2N) relaying, and the relay UE device establishes a communication path between the remote UE and a base station (gNB) or cell. In some situations, for example, the UE device may be out of the service area of the base station, and the relay UE device provides a communication link routed from such an out-of-coverage (OoC) UE device through the relay UE device to the base station. Where the destination device is another UE device (target UE device, peer UE device, destination UE device, etc.), the relaying functionality is typically referred to as UE-to-UE (U2U) relaying.

Thus, sidelink relaying functionality allows a remote UE that is out-of-coverage (OoC) to connect with the gNB or base station via a relay UE device. With UE-to-Network (U2N) relaying, the relay UE needs to be in coverage of a cell and connected to the gNB. The relayed connection from the remote UE device to the base station (gNB) includes (1) a PC5 link (sidelink) between the remote UE device and the relay UE device, and optionally (2) a direct communication link (e.g., Uu link) between the relay UE device and the gNB.

Since the remote UE device and the relay UE device are not assumed to be static, the PC5 link between the remote UE device and the relay UE device may change over time. This is also true for the Uu link between the remote UE device and the gNB. It is possible that the cellular coverage to the remote UE device may change, therefore. In one scenario, the remote UE device is connected through a U2N relay connection and may move from in-coverage to out-of-coverage of the gNB. As a result, it is advantageous to perform a path switch to a U2U relay connection where the same or new relay UE device facilitates the relay connection to the peer UE device. In another scenario, the remote UE device is connected through a U2U relay connection and may move from out-of-coverage to in-coverage of the gNB. As a result, it may be advantageous to perform a path switch to a U2N relay connection where the same or new relay UE device facilitates the relay connection to the peer UE device.

For the examples discussed herein, the relay UE device transmits a trigger message to a first UE device (peer UE device of the remote UE device) when the cellular coverage status of the remote UE device (second UE device) changes. The trigger message may invoke a procedure at the first UE device that at least evaluates one or more alternative relay paths between the remote UE device and the peer UE device. The trigger message is transmitted in response to receipt of a coverage change indication message at the relay UE device and, in some cases, may be the coverage change indication message forwarded by relay UE device.

Where the relay UE device is facilitating a U2N relay communication link between the remote UE device and the peer UE device, relay UE device receives information from the serving gNB that the remote UE device is leaving the coverage area of the gNB. For such as scenario, therefore, the change in coverage message is a message from the gNB. The relay UE device transmits the trigger message to inform the peer UE device that the remote UE device is, or will be, out of coverage. In response to the trigger message, the peer UE device evaluates alternate U2U relay paths where a relay UE device provides a U2U communication link between the remote

UE device and the peer UE device. A path switch, therefore. can be performed from a U2N relay link to a U2U relay link in response to the trigger message. In some situations, it may be possible for the original relay UE device to provide the U2U relay link. In other situations, a new relay UE device, different from the original relay UE device, facilitates the U2U relay link.

Where the relay UE device is facilitating a U2U relay communication link between the remote UE device and the peer UE device, the relay UE device receives information from the remote UE device indicating that the remote UE device is entering the coverage area of a gNB. For such as scenario, therefore, the change in coverage message is a message received from the remote UE device. The relay UE device transmits the trigger message to inform the peer UE device that the remote UE device is, or will be, in coverage of the gNB. In response to the trigger message, the peer UE device evaluates alternate U2N relay paths where a relay UE device facilitates a U2N communication link between the remote UE device and the peer UE device through the gNB. A path switch, therefore, can be performed from a U2U relay link to a U2N relay link in response to the trigger message. In some situations, where the original relay UE device is in coverage of the gNB, for example, it may be possible for the original relay UE device to provide the U2N relay link. In other situations, a new relay UE device, different from the original relay UE device, is selected to facilitate the U2N relay link.

Although the techniques discussed herein may be applied to various types of systems and communication specifications, the devices of the example operate in accordance with at least one revision of the 3^{rd} Generation Partnership Project (3GPP) New Radio (NR) V2X communication specification. The techniques discussed herein, therefore, may be adopted by one or more future revisions of communication specifications, although the techniques may be applied to other communication specifications where sidelink or D2D and relay functionality are employed. More specifically, the techniques may be applied to current and future releases of 3GPP NR specifications. For example, the techniques may also be applied to 3GPP NR (3GPP Rel-17) and 3GPP Rel-18.

Although the different examples described herein may be discussed separately, any of the features of any of the examples may be added to, omitted from, or combined with any other example. Similarly, any of the features of any of the examples may be performed in parallel or performed in a different manner/order than that described or shown herein.

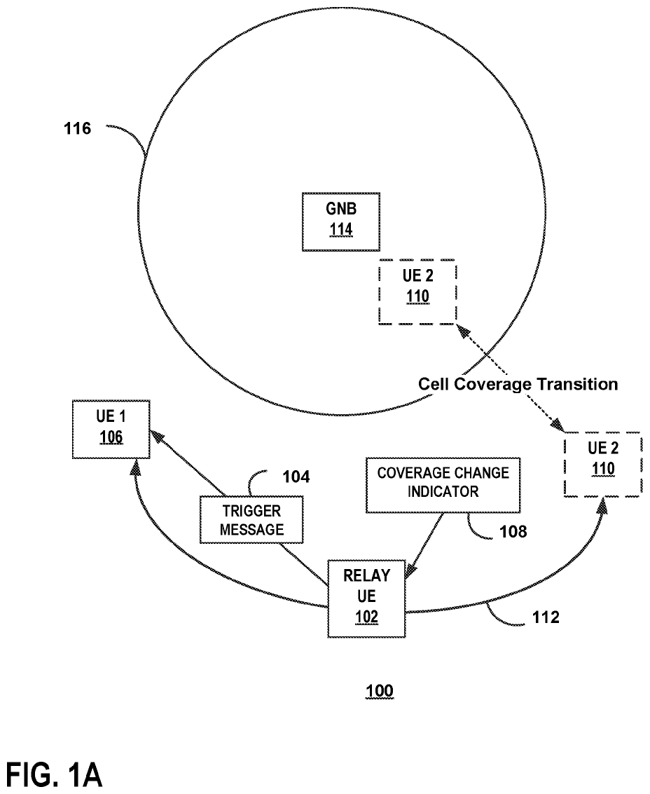

FIG. 1A is a block diagram of an example of a system 100 where a relay UE device 102 sends a trigger message 104 to a first UE device (peer UE device) 106 in response to receiving a coverage change indication message 108. The coverage change indication message 108 indicates a change in conditions has been detected that has changed (or may change) the cellular coverage status of a second UE device (remote UE device) 110 where the change may be from in-coverage (InC) to out-of-coverage (OoC) or may be from out-of-coverage (OoC) to in-coverage (InC).

The relay UE device 102 is providing or otherwise facilitating a relay communication link 112 between the first UE device 106 and the second UE device 110 where the relay communication link 112 may be a U2N relay link or a U2U relay link. Accordingly, the relay communication link 112 may include a Uu link from the relay UE device to a gNB (base station) 114 where the relay UE device 102 is facilitating a U2N relay link. In other situations, the relay communication link 112 may include a PC5 link from the relay UE device to the second UE device 110 where the relay UE device 102 is facilitating a U2U relay link. The gNB 114 provides cellular coverage within a geographical cellular coverage region 116 where devices within the coverage region 116 are capable of receiving wireless service from the gNB 114. Although the region 116 is depicted as circular in the figure, the region 116 may have any number of shapes and sizes. In some circumstances, the region 116 may include areas (holes) within a larger area where coverage is unavailable.

In some circumstances, the coverage change indication message 108 indicates that the coverage change has been detected and that the coverage status of the second UE device 110 has already changed. Such a situation may occur where the gNB 114 has lost communication with the second UE device 110, for example. In another example of such a situation, the second UE relay device 110 determines it is in-coverage (In-C) based on the signal quality/strength of signals transmitted by the gNB 114.

In other circumstances, the coverage change indication message 108 indicates that a coverage change will occur, or is at least likely to occur. In one example of such a situation, the gNB 114 determines the quality of communication with the second UE device 110 is degrading and that such degradation is result of the second UE device 110 approaching the boundary of the coverage area 116. Such a determination may be made based on whether the measured RSRP level falls below a configured threshold for the case the UE device 110 is moving out of coverage. Similarly, if the measured RSRP level increases above a configured threshold the UE device 110 can determine that it has moved within cellular coverage of the gNB. In general, the RSRP threshold configured for moving in coverage and for moving out of coverage may differ to allow for hysteresis (i.e., ping-ponging). In some situations, the second UE device 110 detects the degradation in communication quality with the gNB 114 and determines it is leaving the coverage area 116.

FIG. 1B is a block diagram of an example of the system 100 where the relay UE device 102 is facilitating a U2N relay link 120 and the remote UE device (second UE device) 110 transitions to out-of-coverage (OoC) of the cellular coverage regions 116. The scenario of FIG. 1B, therefore, is an example of the FIG. 1A where the relay communication link 112 is a U2N relay link 120 and the second UE device 110 begins in-coverage (InC) of the gNB 114. Although the first UE device 106 is shown outside of the cellular coverage region 116, the first device 106 may either be in-coverage or out-of-coverage but is within service range of the relay UE device 102. The relay UE device 102 is in communication with the gNB 114. For the example, the relay UE device 102 is within the coverage area 116 of the gNB 114. In some situations, however, the U2N relay link 120 may include multiple relay UE devices where one or more relay UE devices are out of coverage but at least one relay UE device is in coverage.

For the example of FIG. 1B, the gNB 114 determines that the second UE device 120 has transitioned to out-of-coverage or is likely to transition to out-of-coverage. The determination may be based on various factors and/or parameters. For the example, coverage information 122 received from the second UE device 110 is evaluated by the gNB 114 to make the determination where the determination is based, at least partially, on the coverage information 122. In one example, the coverage information 122 comprises a measurement report that indicates the second UE device 110 is leaving the coverage region 116. The measurement report is evaluated by the gNB 114 to determine the likely position of the second UE device 110. Where the measurement report indicates a substantially low signal strength of signals received from the gNB, for instance, the gNB 114 may conclude that the second UE device 110 is nearing the boundary of the coverage area 116. The measurement report may indicate higher signal strengths transmitted from other devices (e.g., other gNBs) indicating at least a general geographical position of second UE device 110. The gNB 114 may determine such a position is near the coverage area 116 boundary. The gNB 114 may evaluate other factors in determining whether the second UE device 110 is leaving coverage. An example of one such factor includes previous measurement reports where a trend or trajectory of movement of the second UE device 110 may be detected. In another example, the second UE device 110 transmits a Radio Resource Control (RRC) message indicating a change in coverage. Such a situation may occur where the second UE device detects a degrading quality of the communication link with the gNB 114 (e.g., decreasing signal strength) and determines that it is likely leaving the coverage area 116. The second UE device 110 may also detect signals from other devices that indicate it is leaving the coverage area 116. For the example, the RRC message is a SidelinkUEInformation message. SidelinkUEInformation messages are RRC messages that are used by UE devices to provide information related Sidelink to the gNB. In one example, the transmission of the RRC message is triggered by a change in the measured RSRP level. The RRC message, therefore, may be transmitted when the RSRP falls below a minimum threshold. In another example, the RRC message is transmitted in response to a determination that the second UE device is no longer the RRC connected state (RRC CONN). When the second UE device goes OoC, it cannot maintain the RRC CONN state. In such examples, the second UE device transmits the RRC message to the gNB via U2N relay link. In these examples, therefore, the RRC message can only be sent to the gNB when a communication link is available to the gNB.

In response to the determination that the second UE device has experienced, or will experience, a coverage change, the gNB 114 sends a coverage change indication message 108 to the relay UE device 102. In response to the coverage change indication message 108, the relay UE device transmits a trigger message 104 to the first UE device 106. In some situations, the trigger message 104 is a forwarded version of the coverage change indication message 108. The coverage change indication message 108, therefore, may be a message sent by the gNB 114, directed to the first UE device 106 and relayed by the relay UE device. For the example, the gNB 114 sends a coverage change indication message 108 to the relay UE device 102 using an RRC Reconfiguration message, then the trigger message 104 sent from the relay UE device is an RRC message, such as a Notification Message Sidelink message. In another example. the RRC message is sent directly to the first UE device in some circumstances, using the RRC Reconfiguration message that is only meant for the second UE device. This RRC message is sent via the relay UE device over the U2N relay link, but the content of the message is transparent to the relay UE device.

In response to receiving the trigger message 104, the first UE device (peer UE device) 106 at least evaluates alternative communication paths to the second UE device. For the example, the first UE device 106 executes a relay reselection procedure to identify a U2U relay link 124 to the second UE device 110. Accordingly, the first UE device 106 may evaluate neighbor lists of nearby UE device to identify a relay UE device 126 that can facilitate the U2U relay link 124 to the second UE device 110. In some situations, the relay UE device 102 may be selected to provide the U2U relay link 124. The first UE device 106 may determine that a direct PC5 link can be established with the second UE device 110 in some situations. Accordingly, the selected alternate communication path may be a direct PC5 link between the first UE device 106 and the second UE device 110.

In one example, the determination that the second UE device 110 is at least likely to transition from within cellular coverage to out of cellular coverage is based on a measured RSRP level at the second UE device relative a threshold. The measured RSRP level at the second UE device may be compared to a minimum out of coverage threshold and where measured RSRP level is less than the minimum out of coverage threshold, it is determined that the second UE device is at least likely to transition from within the cellular coverage to out of the cellular coverage.

FIG. 1C is a block diagram of an example of the system 100 where the relay UE device 102 is facilitating a U2U relay link 130 and the remote UE device (second UE device) 110 transitions from out of coverage (OoC) to in-coverage (InC) of the cellular coverage region 116 of a gNB 114. The scenario of FIG. 1C, therefore, is an example of the FIG. 1A where the relay communication link 112 is a U2U relay link 120 and the second UE device 110 begins in the out-of-coverage (OoC) state. Although the first UE device 106 is shown outside of the cellular coverage region 116, the first device 106 may either be in-coverage or out-of-coverage but is within service range of the relay UE device 102. Although the relay UE device 102 is shown outside of the cellular coverage region 116, the relay UE device 102 may either be in-coverage or out-of-coverage.

For the example of FIG. 1C, the second UE device 120 determines that it has transitioned to in-coverage, or is likely to transition to in-coverage, of a gNB 114. The determination may be based on various factors and/or parameters. For the example, the second UE device 110 evaluates reference signals transmitted by the gNB 114 to determine it is entering or has enter the cellular coverage region 116 of the gNB 114. The second UE device 110 determines it is in-coverage when RSRP measurements exceed an in-coverage RSRP threshold, which may be based on the threshold used for determining whether the concerned cell meets the S criteria followed by the determination of whether the concerned cell is a suitable cell. Such measurements are typically performed in conventional systems at least because a UE device must only use sidelink communication resources configured by the gNB to avoid interference within the cell. Once the UE device is within coverage of the gNB, it can no longer use pre-configured sidelink resources. The S Criteria is defined by at least one communication specification and allows UE devices to determine whether a measured value at the UE device (e.g., measured RSRP signal, measured RSRQ) is above the corresponding configured threshold. In some situations, the S Criteria is used to determine that the second UE device is out of coverage when the second UE device is unable to detect any cell meeting the S criterion.

In response to the determination that it is or will be in-coverage, the second UE device 110 sends a coverage change indication message 108 to the relay UE device 102. In response to the coverage change indication message 108, the relay UE device transmits a trigger message 104 to the first UE device 106. In some situations, the trigger message 104 is a forwarded version of the coverage change indication message 108. The coverage change indication message 108, therefore, may be a message sent by the second UE device 110, directed to the first UE device 106, and relayed by the relay UE device 102. Two examples of suitable techniques for sending the coverage change indication message 108 include sending a PC5-RRC message, such as a NotificationMessageSidelink message, and sending PC5-S message, such as a discovery message. These messages can be sent either via an end-to-end (E2E) communication of via a hop-by-hop (HbH) communication. An E2E PC5-S message or E2E PC5-RRC message sent via a PC5 unicast link which is transparent to the relay UE device 102. For the HbH communication, the relay UE device 102 receives the PC5-RRC message or PC5-S message, determines the contents, and generates and transmits a corresponding message to the first UE device. When E2E messaging are used, the trigger message and the change in coverage indication message are the same message that is forwarded by the relay UE device. For the HbH communication, the trigger message is generated by the relay UE device based on the change in coverage indication message.

In response to receiving the trigger message 104, the first UE device (peer UE device) 106 at least evaluates alternative communication paths to the second UE device 110. For the example, the first UE device 106 executes a relay reselection procedure to identify a U2N relay link 132 to the second UE device 110. Accordingly, the first UE device 106 may evaluate discovery signals transmitted from nearby UE devices to identify a relay UE device 134 that can facilitate the U2N relay link 132 to the second UE device 110. In accordance with conventional techniques, UE devices capable of serving as U2N relay UE devices transmit U2N discovery signals indicating the capability. At least partially based on the received U2N discovery signals, the first UE device 104 selects the appropriate UE device to serve as the U2N relay UE device 134. In some situations, the relay UE device 102 may be selected to provide the U2N relay link 132. Accordingly, the relay UE device 134 may be the relay UE device 102. Where the first UE device is in-coverage of a gNB the selected new communication link may include a Uu link from the first UE device 106 to the gNB where the gNB may be the gNB 114 providing service to the second UE device 110 or may be another gNB.

In one example, the determination that the second UE device 110 is at least likely to transition from out of cellular coverage to within cellular coverage is based on a measured RSRP level at the second UE device relative to a threshold. The measured RSRP level at the second UE device may be compared to a minimum in coverage threshold and, where measured RSRP level is less than the minimum in coverage threshold, it is determined that the second UE device is at least likely to transition from outside of the cellular coverage to within the cellular coverage.

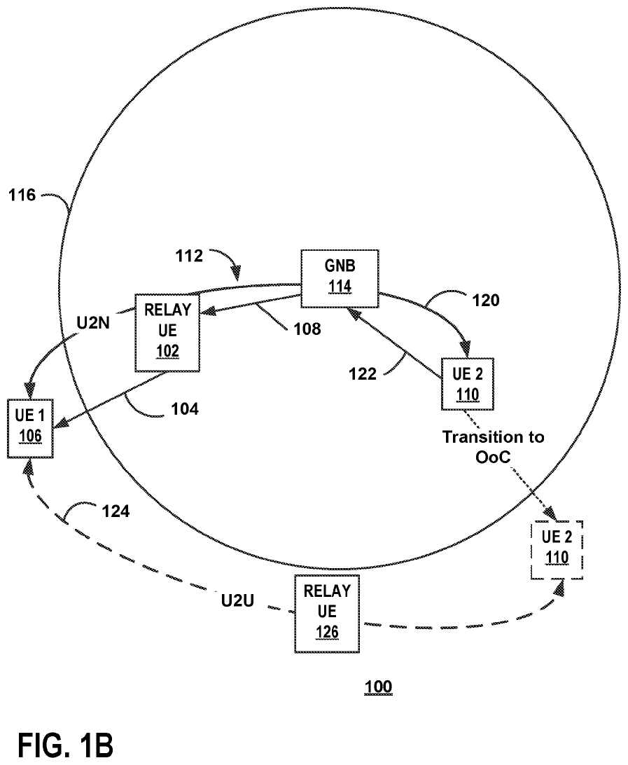

FIG. 2 is a block diagram of an example of a base station (gNB) 200 suitable for use as the gNB 114. The base station 200 includes a controller 204, transmitter 206, and receiver 208, as well as other electronics, hardware, and code. The transmitter 206 and receiver 208 for a transceiver. The base station 200 is any fixed, mobile, or portable equipment that performs the functions described herein. The various functions and operations of the blocks described with reference to the base station 106 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory 205. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. The antenna 210 may also include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators. matching circuits. and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

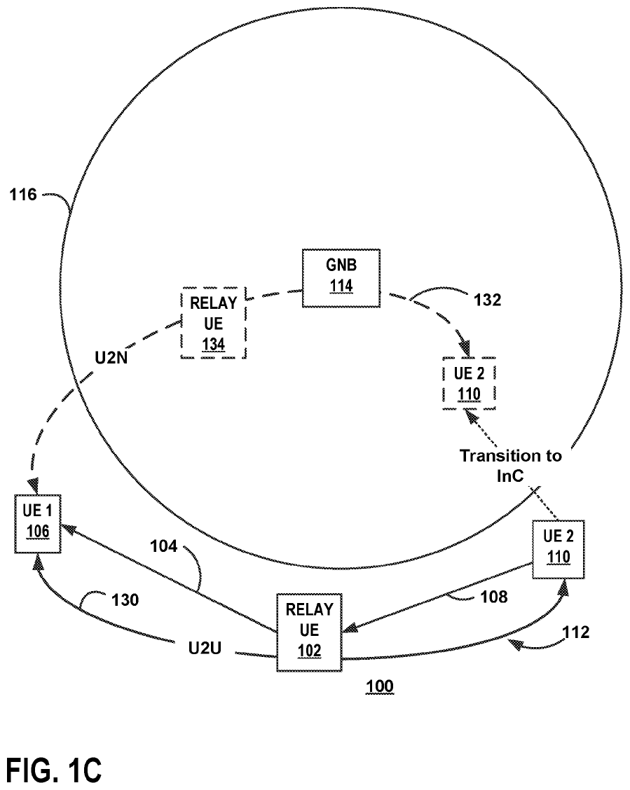

FIG. 3 is a block diagram of an example of a UE device 300 suitable for use as each of the UE devices 102, 106, 110, 134. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IoT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The transmitter 304 and receiver 306 form a transceiver. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators. matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

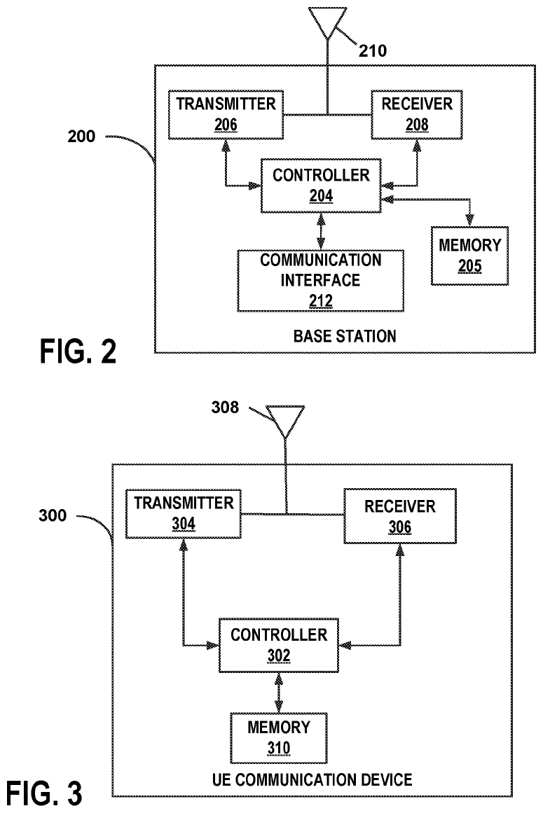

FIG. 4 is a flow chart of an example of a method 400 of sending cellular coverage change information to a first UE device regarding the change in coverage of a second UE device. Accordingly, the method may be performed by the relay UE device 102.

At step 402, a relay communication link is established between the first UE device and the second UE device where data is exchanged between the first UE device and the second UE device. The transceiver in the relay UE device transmits and receiver signals to establish the relay communication link where data is exchanged between the first UE device and the second UE device through at least the relay UE device. In some situations, the relay communication link is a U2U relay link and, in other situations, the relay communication link is a U2N relay link.

At step 404, a coverage change indication message is received. The coverage change indication message indicates that cellular coverage provided by a base station for the second UE device is changing. The receiver in the transceiver is configured to receive the coverage change indication message which may indicate the second UE device is transitioning from within cellular coverage to outside cellular coverage or is transitioning from outside cellular coverage to within cellular coverage of a base station (gNB) 114. Where the relay communication link is a U2N relay link that includes the base station, the coverage change indication message is received from the base station and indicates that the second UE device is at least likely to leave coverage of the base station. The coverage change indication message in the U2N case, therefore, indicates that the second UE device is transitioning, likely to transition, or has transitioned from being within cellular coverage to being outside cellular coverage.

Where the relay communication link is a U2U relay link that does not include the base station, the coverage change indication message is received from the second UE device and indicates that the second UE device is at least likely to enter cellular coverage. The coverage change indication message in the U2U case, therefore, indicates that the second UE device is transitioning, likely to transition, or has transitioned from being outside cellular coverage to being within cellular coverage.

At step 406, a trigger message is transmitted to the first UE device. The transmitter in the transceiver of the relay UE device is configured to transmit the trigger message to the first UE device to initiate a path switch to an alternate communication path between the first UE device and the second UE device. Where the relay communication link is a U2N relay link, the trigger message indicates that the second UE device is at least likely to leave coverage of the base station to invoke the first UE device to perform a relay reselection procedure to establish a new communication link between the first UE device and the second UE device without the base station.

In some situations, the relay UE device simply forwards the coverage change indication message as the trigger message without decoding the coverage change indication message. The contents of coverage change indication message may be transparent to the relaye UE device. In other situations, the relay UE device receives the coverage change indication message and generates the trigger message to send to the first UE device. The trigger message and the coverage change indication message may each include a signal quality indicator indicative of a quality of a communication link between the base station and the second UE device.

In some situations, the change indication message may include or be based on a measured RSRP level at the second UE device. The determination that a coverage change will, is likely to, or has occurred may be based on whether the measured RSRP has crossed a threshold. In some cases, the new communication link is a U2U relay link. In other cases, the new communication link is a direct PC5 link between the UE device 106, 110. In some situations, it may be determined that the measured RSRP level is greater than a minimum in-coverage threshold where the minimum in-coverage threshold is a minimum RSRP level for determining that the second UE device is at least likely to transition from out of the cellular coverage to within the cellular coverage. The minimum in-coverage threshold may be a minimum RSRP level for determining that the second UE device has transitioned from out of the cellular coverage to within the cellular coverage. In other situations, it may be determined that the measured RSRP is less than a minimum out of coverage threshold where the minimum out of coverage threshold is a minimum RSRP level for determining that the second UE device is at least likely to transition from within the cellular coverage to out of the cellular coverage.

The minimum out of coverage threshold may be a minimum RSRP level for determining that the second UE device has transitioned from within the cellular coverage to out of the cellular coverage. Other techniques can be used to determine that the cellular coverage of the second UE device has changed. The determination may be based on whether the RRC CONNECTED state of the second UE device has changed, for example.

Where the relay communication link is a U2U relay link that does not include the base station, the trigger message indicates that the second UE device has entered coverage of the base station to invoke the first UE device to perform a relay reselection procedure to establish a new communication link between the first UE device and the second UE device that includes the base station. The new communication link may be a U2N relay link between the first UE device and the second UE device that includes the base station. In some situations, the new communication link includes a first Uu link between the first UE device and the base station and a second Uu link between the base station and the second UE device. The new communication link may also include a first Uu link between the first UE device and another base station (different from the base station serving the second UE device) and a second Uu link between the base station and the second UE device.

In other examples, one or more of the steps of the method 400 may be omitted, combined, performed in parallel, or performed in a different order than that described herein or shown in FIG. 4. In still further examples, additional steps may be added to method 400 that are not explicitly described in connection with the example shown in FIG. 4.

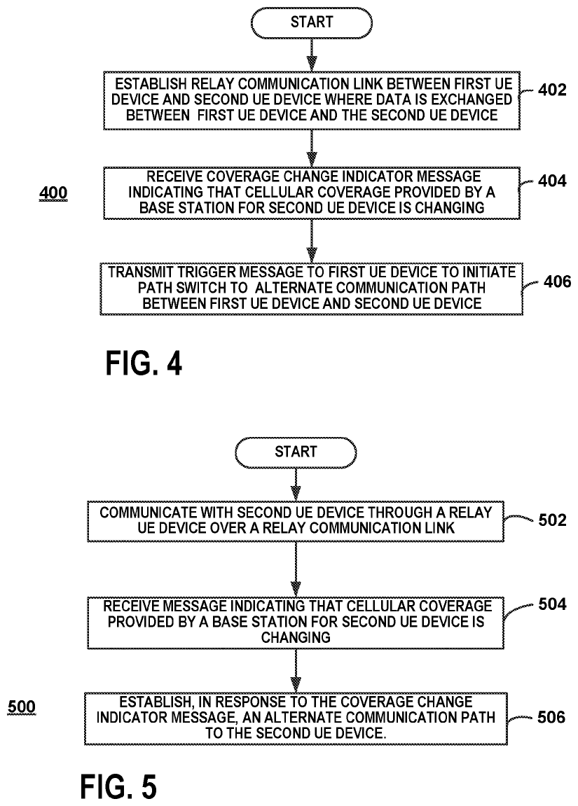

FIG. 5 is a flow chart of an example of a method 500 of establishing an alternate communication path to second UE device in response to receiving message indicating that the cellular coverage to the second UE device has changed. Accordingly, the method may be performed by the first UE device 106.

At step 502, the first UE device communicates with the second UE device through a relay UE device over a relay communication link. The transceiver is configured to exchange between the first UE device and the second UE device through at least the relay UE device. In some situations, the relay communication link is a U2U relay link and, in other situations, the relay communication link is a U2N relay link.

At step 504, a message is received indicating that cellular coverage provided by a base station for the second UE device is changing. The message may be a cover change indication message transmitted by either the base station or the second UE device. The message may also be a trigger message transmitted by the relay UE device that is based on a coverage change indication message received at the relay UE device. In some situations, the trigger message may be the coverage change indication message transmitted by the second UE device or base station and then forwarded by the relay UE device.

At step 506, an alternate communication path to the second UE device is established in response to the message. A controller in the first UE device evaluates the trigger message or the coverage change indication message and establishes an alternate communication path to the second UE device. Where the relay communication link is a U2U relay link and the message indicates that the second UE device is at least likely to transition from outside cellular coverage to within cellular coverage of the base station, the alternate communication path is a U2N relay communication link comprising communication through the base station.

Where the relay communication link is a U2N relay communication link with communication through the base station and the message indicates that the second UE device is at least likely to transition from within cellular coverage to outside of cellular coverage of the base station, the alternate communication path is one of a U2U relay communication link comprising communication through the relay UE device, a U2U relay communication link comprising communication through another relay UE device, or a direct PC5 communication link between the first UE device and the second UE device.

In other examples, one or more of the steps of the method 500 may be omitted, combined, performed in parallel, or performed in a different order than that described herein or shown in FIG. 5. In still further examples, additional steps may be added to method 500 that are not explicitly described in connection with the example shown in FIG. 5.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a transceiver configured to establish a relay communication link between a first UE device and a second UE device where data is exchanged between the first UE device and the second UE device through at least the relay UE device;
the transceiver comprising a receiver and a transmitter,
the receiver configured to receive a coverage change indication message indicating that cellular coverage provided by a base station for the second UE device is changing,
the transmitter configured to transmit a trigger message to the first UE device to initiate a path switch to an alternate communication path between the first UE device and the second UE device.

2. The relay UE device of claim 1, wherein:
the relay communication link is a U2N relay link that includes the base station;
the coverage change indication message is received from the base station and indicates that the second UE device is at least likely to leave coverage of the base station; and
the trigger message indicates that the second UE device is at least likely to leave coverage of the base station to invoke the first UE device to perform a relay reselection procedure to establish a new communication link between the first UE device and the second UE device without the base station.

3. The relay UE device of claim 2, wherein the new communication link is a U2U relay link between the first UE device and the second UE device without the base station.

4. The relay UE device of claim 2, wherein the new communication link is a direct PC5 link between the first UE device and the second UE device.

5. The relay UE device of claim 1, wherein the trigger message is the coverage change message received and forwarded by the relay UE device and the coverage message is not decoded by the relay UE device before forwarding the coverage message as the trigger message.

6. The relay UE device of claim 1, wherein the trigger message and the coverage change message each comprise a signal quality indicator indicative of a quality of a communication link between the base station and the second UE device.

7. The relay UE device of claim 1, wherein the coverage change indication message is transmitted in response to a determination that the second UE device is unable to detect a cell meeting an S criterion.

8. The relay UE device of claim 1, wherein the coverage change indication message is transmitted in response to a determination that a measured RSRP level at the second UE device is greater than a minimum in-coverage threshold, wherein the minimum in-coverage threshold is a minimum RSRP level for determining that the second UE device is at least likely to transition from out of the cellular coverage to within the cellular coverage.

9. The relay UE device of 8, wherein the minimum in-coverage threshold is a minimum RSRP level for determining that the second UE device has transitioned from out of the cellular coverage to within the cellular coverage.

10. The relay UE device of claim 1, wherein the coverage change indication message is transmitted in response to a determination that a measured RSRP level at the second UE device is less than a minimum out of coverage threshold, wherein the minimum out of coverage threshold is a minimum RSRP level for determining that the second UE device is at least likely to transition from within the cellular coverage to out of the cellular coverage.

11. The relay UE device of claim 10, wherein the minimum out of coverage threshold is a minimum RSRP level for determining that the second UE device has transitioned from within the cellular coverage to out of the cellular coverage.

12. The relay UE device of claim 1, wherein the coverage change indication message is transmitted in response to a determination that the RRC CONNECTED state of the second UE device has changed.

13. The relay UE device of claim 1, wherein:
the relay communication link is a U2U relay link that does not include the base station;
the coverage change indication message is received from the second UE device and indicates that the second UE device has entered coverage of the base station; and
the trigger message indicates that the second UE device has entered coverage of the base station to invoke the first UE device to perform a relay reselection procedure to establish a new communication link between the first UE device and the second UE device that includes the base station.

14. The relay UE device of claim 13, wherein the new communication link is a U2N relay link between the first UE device and the second UE device that includes the base station.

15. The relay UE device of claim 14, wherein the new communication link comprises a first Uu link between the first UE device and the base station and a second Uu link between the base station and the second UE device.

16. The relay UE device of claim 14, wherein the new communication link comprises a first Uu link between the first UE device and another base station and a second Uu link between the base station and the second UE device.

17. The relay UE device of claim 13, wherein the trigger message is the coverage change message received and forwarded by the relay UE device.

18. A first user equipment (UE) device comprising:
a transceiver configured to communication with the second UE device through a relay UE device over a relay communication link where data is exchanged between the first UE device and the second UE device through at least the relay UE device;
the transceiver comprising a receiver configured to receive a message indicating that cellular coverage provided by a base station for the second UE device is changing; and
a controller configured to establish, in response to the message, an alternate communication path to the second UE device.

19. The first UE device of claim 18 wherein:
the relay communication link is a U2U relay communication link;
the message indicates that the second UE device is at least likely to transition from outside cellular coverage to within cellular coverage of the base station; and
the alternate communication path is a U2N relay communication link comprising communication through the base station.

20. The first UE device of claim 18, wherein:
the relay communication link is a U2N relay communication link comprising communication through the base station;
the message indicates that the second UE device is at least likely to transition from within cellular coverage to outside of cellular coverage of the base station; and
the alternate communication path is one of:
a U2U relay communication link comprising communication through the relay UE device;
a U2U relay communication link comprising communication through another relay UE device; or
a direct PC5 communication link between the first UE device and the second UE device.
